(19) United States
(12) Patent Application Publication
(10) Pub. No.: US 2014/0058793 A1
(43) Pub. Date: Feb. 27, 2014

(54) FORECASTING A NUMBER OF IMPRESSIONS OF A PROSPECTIVE ADVERTISEMENT LISTING

(71) Applicants: Abhirup Nath, Bangalore (IN); Shibnath Mukherjee, Bangalore (IN); Prateek Jain, Bangalore (IN); Navin Goyal, Bangalore (IN); Srivatsan Laxman, Bangalore (IN)

(72) Inventors: Abhirup Nath, Bangalore (IN); Shibnath Mukherjee, Bangalore (IN); Prateek Jain, Bangalore (IN); Navin Goyal, Bangalore (IN); Srivatsan Laxman, Bangalore (IN)

(73) Assignee: Microsoft Corporation, Redmond, WA (US)

(21) Appl. No.: 13/590,192

(22) Filed: Aug. 21, 2012

(51) Int. Cl. G06Q 30/02

(52) U.S. Cl. 705/7.31

(57) ABSTRACT

Technologies pertaining to advertisement impression forecasting are described herein. An advertiser sets forth a proposed bid value for a prospective advertisement listing with respect to a keyword for a defined range of time. A number of auctions for the keyword in which the prospective advertisement listing will participate is estimated. A generative model that models auctions for the keyword is sampled to simulate auctions for the keyword, wherein the number of simulated auctions is equivalent to the number of auctions for the keyword in which the prospective advertisement listing is estimated to participate. For each simulated auction, a determination is made regarding whether the prospective advertisement listing wins the auction based upon the proposed bid value set forth by the advertiser. A number of simulated auctions won by the prospective advertiser is output as a forecasted number of impressions for the advertisement over the defined range of time.

### BACKGROUND

Sponsored search engines generate revenue by auctioning conducting auctions for advertising positions on search results pages responsive to receipt of at least one keyword (which can be all or a portion of a query). With more particularity, advertisers can submit bids for a keyword; accordingly, when a user issues a query that includes the keyword, the search engine conducts an auction amongst advertisers who wish to present advertisements to the user, wherein the advertisers submit bids, and an advertisement listing of the winning advertiser is presented to the user. Generally, when a user selects an advertisement presented in such manner, the sponsored search engine is paid a fee by the winning advertiser.

Advertisers, however, often find it difficult to effectively employ their advertising budget for keyword auctions. This is at least partially due to difficulties in forecasting a number of times that the advertiser will win auctions for a desired keyword over some threshold amount of time (one week). In an example, an advertiser may have a set advertising budget for a defined range of time, and the goal of the advertiser is to maximize effectiveness of an advertising campaign while considering the budget constraints. Accordingly, the advertiser may desire to exhaust the budget while obtaining a maximum number of impressions over the defined range of time.

Currently, sponsored search engines assist advertisers in predicting a number of impressions for a prospective advertisement listing by receiving a bid value from the advertiser for a keyword for the prospective advertisement listing, and thereafter re-executing historical auctions (over some defined time range) to determine how many auctions the advertiser would win given the bid value. Such approach is sub-optimal for several reasons. First, auctions that occur, for instance, a week ago are not equivalent to auctions that will occur next week, as query patterns change, advertisers change, bid values change, and the like. Additionally, re-executing historic auctions does not readily support forecasting impressions for a prospective advertisement listing that is non-existent in auction logs.

### SUMMARY

The following is a brief summary of subject matter that is described in greater detail herein. This summary is not intended to be limiting as to the scope of the claims.

Described herein are various technologies pertaining to a sponsored search. With more specificity, described herein are various technologies pertaining to forecasting a number of impressions of a prospective advertisement listing over a predefined time range for a particular keyword. In an exemplary embodiment, the defined time range can be one week (in the future). Forecasting a number of impressions over the defined time range can be undertaken through utilization of a generative model that is configured to model auctions for the aforementioned keyword. In an exemplary embodiment, the generative model can be a Bayesian network. The generative model can be learned through analysis of historic auctions for the keyword. Pursuant to an example, for each keyword auction, the search engine can collect query features for a query that initiated a respective auction, scores of advertisement listings that participated in the respective auction, and winning scores for the respective auction. Exemplary query features can include time that the query was issued, location from which the query was issued, a category assigned to the query by the sponsored search engine, and the like. A winning score for the respective auction is based upon a bid value of an advertisement listing that won the auction and a probability that the advertisement listing will be selected by an issuer of the query to the sponsored search engine. Auction data can be collected and retained for purposes of analysis for some defined time period (1 month, 2 months, 3 months, etc.), and the generative model can be learned using such auction data.

A learned generative model that models auctions for a keyword can be employed to forecast a number of impressions for a prospective advertisement listing based at least in part upon a bid value for the prospective advertisement listing. Specifically, a bid can be set forth for the prospective advertisement listing (e.g., by an advertiser) for auctions for the keyword over some defined time range (one week). Responsive to receiving an indication that the prospective advertisement listing desirably participates in auctions with the proposed bid value for the keyword, a number of auctions to be sampled from the generative model (simulated) can be computed. Such number of auctions can be based upon an expected number of auctions conducted for the keyword over the defined time range (an expected number of times that the keyword will be issued by users of the sponsored search engine over the defined time range), as well as an expected percentage of auctions in which the prospective advertisement listing is to participate. Subsequent to computing this number of auctions to be sampled, the generative model can be sampled such number of times to simulate the computed number of auctions.

Each simulated auction has a winning score associated therewith, and for each simulated auction, a respective advertisement listing score can be computed for the prospective advertisement listing. The advertisement listing score is based upon the bid value set forth for the prospective advertisement listing and an estimated probability that an issuer of the query will select the prospective advertisement listing if presented to the issuer subsequent to the issuer setting forth the keyword to the sponsored search engine. Thereafter, for each simulated auction, a respective winning score can be compared with a respective advertisement listing score for the prospective advertisement listing to ascertain if the prospective advertisement listing would win a respective simulated auction. The number of impressions for the prospective advertisement listing can be forecasted by counting the number of simulated auctions predicted to be won by the prospective advertisement listing given the bid value set forth for the prospective advertisement listing. It can therefore be ascertained that an advertiser can, if desired, empirically determine a desirable bid value for a prospective advertisement listing for a certain keyword in a keyword auction settings by submitting different bid values, analyzing respective forecasted impressions for the different bid values, and select the bid value for the defined range of time that best meets the goals of the advertiser.

Other aspects will be appreciated upon reading and understanding the attached figures and description.

### BRIEF DESCRIPTION OF THE DRAWINGS

FIG. 1 is a functional block diagram of an exemplary system that facilitates forecasting a number of impressions of a prospective advertisement listing for keyword auctions over a defined range of time.

FIG. 2 is a functional block diagram of an exemplary system that facilitates learning a generative model that is used in connection with forecasting a number of impressions of a prospective advertisement listings for keyword auctions over a defined range of time.

FIG. 3 illustrates an exemplary generative model that can be used in connection with forecasting a number of impressions of a prospective advertisement listings for keyword auctions over a defined time range.

FIG. 4 is a functional block diagram of an exemplary component that facilitates forecasting a number of impressions of a prospective advertisement listing for keyword auctions over a defined time range.

FIG. 5 is a flow diagram that illustrates an exemplary methodology for forecasting a number of impressions of a prospective advertisement listing for keyword auctions over a defined time range based upon a bid value for the prospective advertisement listing.

FIG. 6 is a flow diagram that illustrates an exemplary methodology for learning a generative model that can be employed in connection with simulating auctions for a keyword.

FIG. 7 is an exemplary computing system.

### DETAILED DESCRIPTION

Various technologies pertaining to advertisement impression forecasting will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Furthermore, a component or system can refer to a processor configured to perform certain actions, a core of a processor, at least a portion of a system on chip (SoC) or cluster on chip (SoC) system, or an integrated circuit, such as a field-programmable gate array (FPGA) that is configured to perform certain actions described herein.

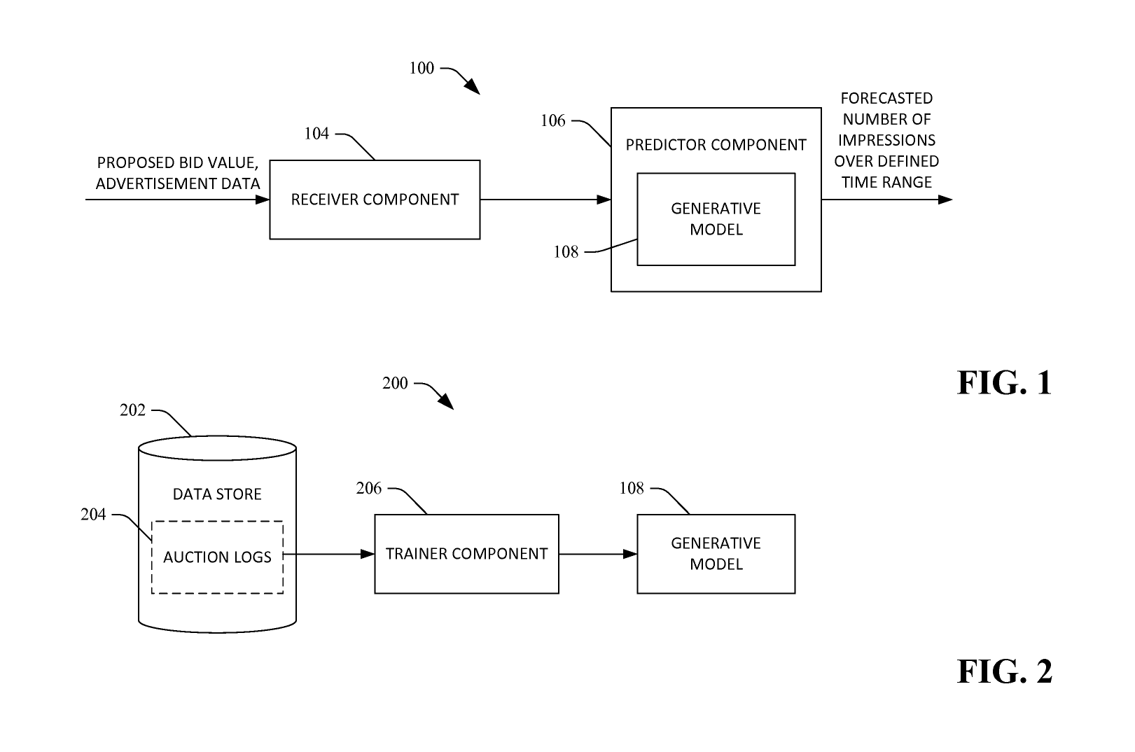

With reference now to FIG. 1, an exemplary system 100 that facilitates advertisement impression forecasting is illustrated. The system 100 is configured to forecast a number of impressions for a prospective advertisement listing over a defined range of time, with respect to a keyword, based upon a proposed bid value for the prospective advertisement listing. As will be described in greater detail below, advertisement impression forecasting is facilitated by modeling auctions through utilization of a generative model. In an exemplary embodiment, the generative model can be a Bayesian network that models keyword features in addition to winning advertisement listing scores (e.g., lowest scores needed to win respective auctions for the keyword). A total number of auctions for the keyword in which the prospective advertisement listing will participate for the defined range of time can be computed, and the generative model can be sampled that number of times to generate simulated auctions. An assessment can be made for each simulated auction as to whether the prospective advertisement listing wins a respective auction, and a number of impressions of the prospective advertisement listing over the defined range of time can be forecast by counting a number of simulate auctions won by the prospective advertisement listing.

The system 100 includes a receiver component 104 that receives an indication that a prospective advertisement listing is desirably presented by an advertiser to users of the sponsored search engine who issue a query that includes a certain keyword. As will be understood by one skilled in the art, a sponsored search engine conducts an auction for advertising space proximate to search results returned subsequent to a user issuing the query that includes the keyword. Winners of the auction are determined according to scores assigned to advertisement listings that participate in the auction, wherein a score for an advertisement listing is a function of a bid value and a probability that an issuer of the query will select the advertisement listing subsequent to issuing the query that includes the keyword.

As mentioned above, the system 100 facilitates forecasting a number of impressions for a prospective advertisement listing based upon a bid value set forth by an advertiser for the prospective advertisement listing. For purposes of explanation, the description below may refer to the prospective advertisement listing setting forth a bid value for an auction, which is intended to be equivalent to the advertiser setting forth the bid value. The receiver component 104 receives an indication that the prospective advertisement listing is desirably presented by the advertiser to users of the sponsored search engine when the keyword is issued as at least a portion of a query. A “keyword”, as the term is employed herein, can be a portion of a query or an entire query. The receiver component 104 also receives a bid value set forth by the advertiser for the prospective advertisement listing, wherein the bid value is to be employed to compute an advertisement listing score for the prospective advertisement listing when an auction is conducted for the keyword (when a user issues the keyword to the sponsored search engine).

The system 100 further comprises a predictor component 106 that is in communication with the receiver component 104, wherein the predictor component 106 is configured to forecast a number of impressions for the prospective advertisement listing for a keyword based, at least in part, upon the bid value set forth by the advertiser. With more particularity, the predictor component 106 comprises a generative model 108 that models auctions for the keyword. As will be described in greater detail below, the generative model 108 can be learned based upon historical auctions for the keyword. In an exemplary embodiment, the generative model 108 is a Bayesian network that models auctions based upon observed features of the keyword from historic auction logs and scores of advertisement listings that participated in auctions in the historic auction logs. Keyword features that can be considered when learning the generative model 108 include, but are not limited to, data pertaining to a web browser utilized by a user when issuing the keyword, location data pertaining to the keyword (location of a user when the user submitted the query), wherein granularity of location can be restricted by a user or anonymized, IP address of a computing device from which the keyword was issued, time that the keyword is issued (such as time of day, day of week, and the like). Thus, the generative model 108 can model keyword features and minimum scores required to win respective auctions, wherein the minimum scores can take into account various factors, including bid values, click probabilities corresponding to bid values, a number of winners of an auction (oftentimes auctions are positional and include multiple winners), a reserve score set by the sponsored search engine, filtering undertaken by the sponsored search engine, and the like.

In general, the predictor component 106 forecasts a number of impressions of the prospective advertisement listing for a defined range of time (e.g., one week) based at least in part upon the bid value set forth by the advertiser for the keyword. The predictor component 106 performs such forecasting by simulating a computed number of auctions for the keyword by sampling the generative model 108 that models auctions for the keyword. Thereafter, the predictor component 106 can ascertain, for each simulated auction, whether the prospective advertisement listing will win the auction based at least in part upon the bid value set forth by the advertiser.

In more detail, the predictor component 106 estimates a number of auctions in which the prospective advertisement listing will participate in the defined time range (e.g., in the next week). In general, this can be accomplished by analyzing historic query data to predict a number of issuances of the keyword to the sponsored search engine over the defined range of time. Additionally, the predictor component 106 can estimate a percentage of auctions for the keyword in which the prospective advertisement listing is likely to participate. If the prospective advertisement listing has participated in auctions for the keyword in the past, such percentage can be based upon historic participation of the prospective advertisement listing in the historic auction logs. If the prospective advertisement listing or the advertiser is new (not found in the historic auction logs), other mechanisms, which will be described in greater detail below, can be employed to predict the percentage of auctions in which the prospective advertisement listing will participate. The predictor component 106 can then sample the generative model 108 to simulate the estimated number of auctions, and the number of impressions of the advertisement listing can be forecast by the predictor component 106 by counting a number of simulated auctions won by the advertisement listing.

Now referring to FIG. 2, an exemplary system 200 that facilitates learning the generative model 108 is illustrated. The system 200 comprises a data store 202 that retains historic auction logs 204. The historic auction logs 204 can be auction logs for a set amount of time, such as on the order of three months. Other time frames, however, are also contemplated. The auction logs 204 can include various data pertaining to auctions for numerous keywords. The description below makes reference to a particular keyword; it is to be understood that numerous generative models can be learned to model auctions for respective numerous keywords. The auction logs 204 can include, for each auction for a keyword, keyword features, wherein exemplary keyword features have been set forth above. The auction logs 204 can also include, for each auction for the keyword, scores for advertisement listings that participated in a respective auction, wherein the scores are based upon respective bids set forth by advertisers participating in the respective auction. Other historic auction data is also contemplated.

The system 200 further comprises trainer component 206 that can access the auction logs 204 and learn the generative model 108 that models auctions for the keyword. In general, for purposes of constructing the generative model 108, an auction can be viewed by the trainer component 106 as a tuple of 1) features of a keyword that is the subject of the auction, 2) scores for advertisement listings of competitors that participate in the auction, and 3) a score for the prospective advertisement listing.

Sponsored search engines typically extract several features from a query (which includes a keyword) submitted to a search engine by a user. Such features can include, as mentioned above, a location from which the query originated, time that the query was submitted, and the like. Typically, for each auction, scores of advertisement listings depend heavily on such features. In an example, if an advertisement listing obtained several clicks from users in New York, and if a received query originates from New York, then a probability that a user would click on the advertisement listing would tend to be high, thereby leading to a higher score for such advertisement listing in an auction for such keyword. Thus, to model auctions for a particular keyword, keyword features associated with such auctions are desirably modeled.

The generative model 108 also desirably models scores of typical competitors to the prospective advertisement listing. As mentioned above, to forecast a number of impressions for the prospective advertisement listing over a defined time range, a prediction must occur as to whether the prospective advertisement listing will win a given auction. In other words, a minimum score required to win a given auction is desirably predicted. Therefore, the generative model 108 can include a model of the minimum score needed to win an auction for the keyword. Such minimum score can take into account various factors, such as bid values and probability of clicks corresponding to respective bidders in the auction, a number of winners, a reserve score, other filtering criteria, etc.

In an exemplary embodiment, the generative model 108 can be a Bayesian network, where each node of the generative model 108 models either a keyword feature or the minimum score required to win the auction. As will be understood stood by one skilled in the art, Bayesian networks are employed for modeling a set of correlated random variables or features. Such a model is represented by a directed acyclic graph, where every node of the directed acyclic graph represents a random variable or feature. Edges between two nodes capture conditional dependencies between the two nodes. Accordingly, the generative model 108 can satisfy the Markovian property that, given its parents, a node is independent of all other nodes that are not its descendants in the generative model 108. That is

Pr(vᵢ|Fᵢ)=Pr(vᵢ|Gᵢ),

where Fᵢ={vⱼ|vᵢ is a child of vⱼ}, and Gᵢ={vₖ★vₖ is not a descendant of vᵢ}. From the above, it can be ascertained that any member of the joint distribution can be computed using this property. Therefore, the trainer component 206, when learning the generative model 108, can estimate Pr(vᵢ|Fᵢ) at vᵢ.

A Bayesian network is particularly well-suited for categorical data, as discrete conditional probability tables (CPTs) at each node can be relatively easily formed and manipulated to draw samples or inferences. As most keyword features are categorical, and the minimum winning score is relatively easily discretized, a Bayesian network is particularly well-suited for the task of advertisement impression forecasting. Additionally, a form that a joint probability distribution can take can be restricted, thereby avoiding overfitting to the auction logs 204. This can be particularly useful for modeling auctions generated from tail queries (e.g., queries that are relatively infrequently submitted to the sponsored search engine).

In an exemplary embodiment, the trainer component 206 can learn the generative model 108 in a distributed computing environment. As mentioned above, in an exemplary embodiment, the trainer component 206 can generate a CPT for each edge in the generative model 108. It can be ascertained that learning the generative model 108 can be computationally expensive, as cardinalities of some keyword features are relatively large, leading to relatively large CPTs. Accordingly, for instance, a map-reduce framework can be employed to estimate CPTs from the auction logs 204. For instance, it may be desirable to estimate the following conditional probability distribution table: P(vᵢ|Fᵢ), where Fᵢ={vᵢ|vᵢ is a child of vⱼ}. First, all unique values each jεFᵢ can take are located. Thereafter, a reduce operation can be undertaken on each combination of unique values of nodes in Fᵢ, and probability distribution of vᵢ can be found using the obtained records. Such scheme can be implemented relatively easily in any standard map-reduce framework. Generated CPTs can thereafter be employed to construct conditional cumulative distribution functions (CDFs) of each node variable. Obtained CDFs can simplify and speed up a sampling process.

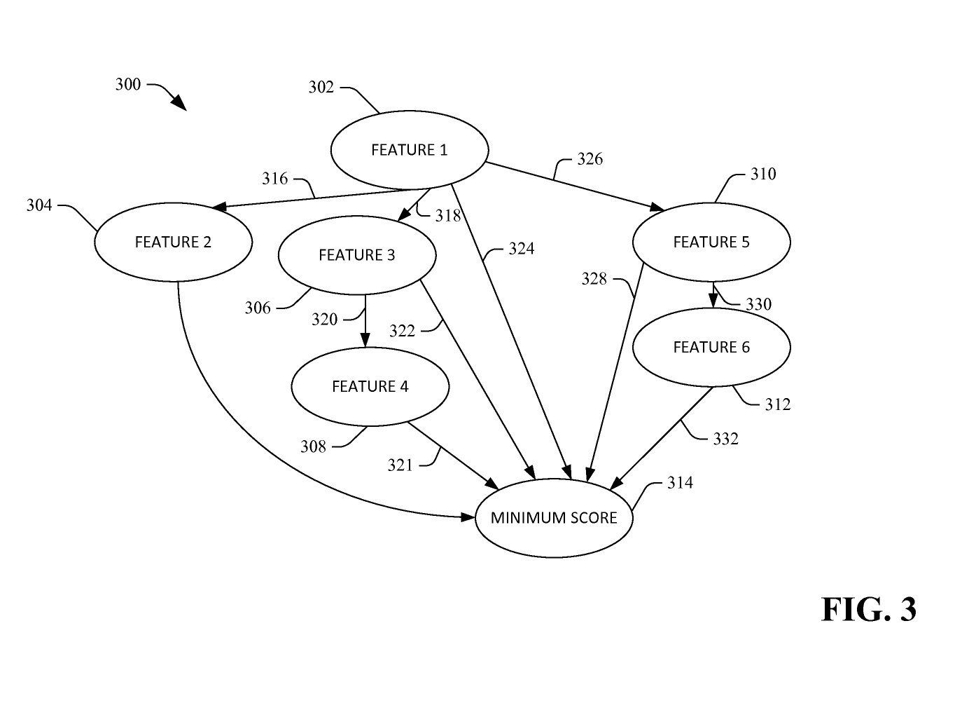

Referring briefly to FIG. 3, an exemplary Bayesian network 300 that can be employed by the predictor component 106 in connection with forecasting impressions of a prospective advertisement listing is illustrated. The Bayesian network 300 includes a plurality of nodes 302-314 and a plurality of edges 316 through 332. Specifically, the edge 316 couples the node 302 with the node 304, the edge 318 couples the node 302 with the node 306, the edge 320 couples the node 306 with the node 308, the edge 321 couples the node 308 with the node 314, the edge 322 couples the node 306 with the node 314, the edge 324 couples the node 302 with the node 314, the edge 326 couples the node 302 with the node 310, the edge 328 couples the node 310 with the node 314, the edge 330 couples the node 310 with the node 312, and the edge 332 couples the node 312 with the node 314. As described above, the trainer component 206 can learn CPTs for each of the edges 316-332.

In an exemplary embodiment, the node 302 can represent an IP address of client computing devices that issued a keyword, the node 304 can represent data pertaining to a browser employed to issue the keyword, the node 306 can represent states from which the keyword was issued, the node 308 can represent metro areas from which the keyword was issued, the node 310 can represent days of the week when the keyword was issued, the node 312 can represent times of day that the keyword was issued, and the node 314 can represent minimum winning scores for auctions for the keyword. As mentioned previously, the node 314 is a child of the nodes 302-312, as the minimum winning score is dependent upon keyword features.

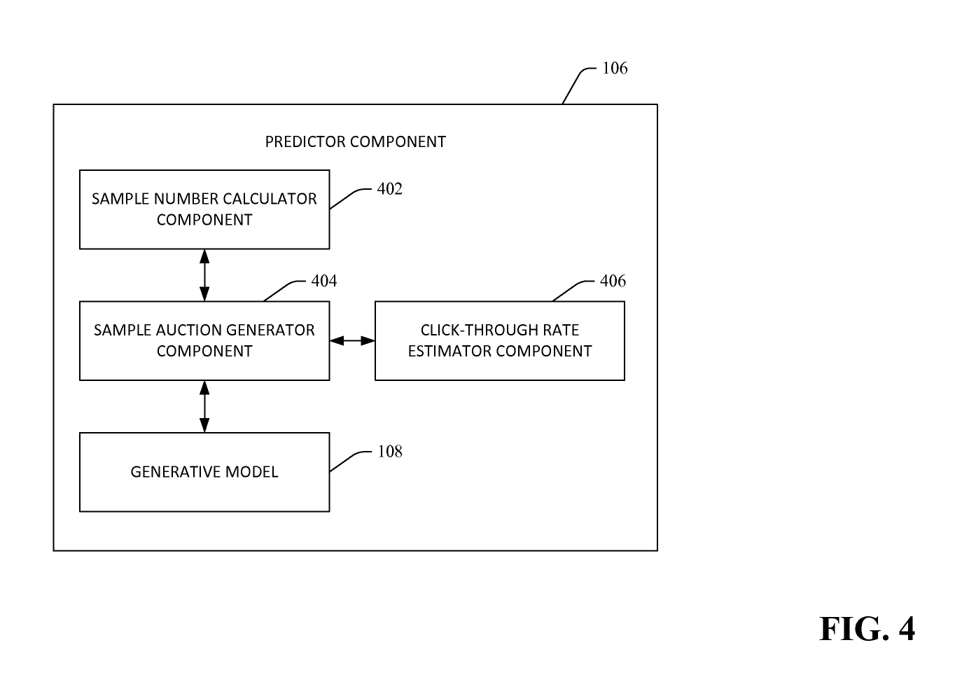

Turning now to FIG. 4, a detailed illustration of the predictor component 106 is set forth. The predictor component 106 comprises the generative model 108, which may be similar to that described above with respect to FIG. 3. The predictor component 106 can comprise a sample number calculator component 402 that computes a number of auctions to be sampled from the generative model 108 based at least in part upon an estimated number of times, in a defined range of time, that the keyword will be issued by users of the sponsored search engine. Additionally, the sample number calculator component 402 can compute the number of auctions to simulate based at least in part upon a predicted percentage of auctions for the keyword in which the prospective advertisement listing will participate. Thus, the sample number calculator component 402 can estimate an expected number of auctions for the keyword in which the prospective advertisement listing will participate in the defined range of time based upon the estimated number of times that the keyword will be issued to the sponsored search engine in the defined range of time and the percentage of auctions for the keyword in which the prospective advertisement listing is estimated to participate. Additional detail pertaining to estimating the number of auctions for the keyword in which the prospective advertisement listing will participate will be set forth below.

The predictor component 106 additionally comprises a sample auction generator component 404 that receives a number of auctions to simulate from the sample number calculator component 402. The sample auction generator component samples the generative model 108 to simulate the number of auctions for the keyword set forth by the sample number calculator component.

The predictor component 106 further comprises a click-through rate estimator component 406 that, for each auction, estimates a click-through rate for the prospective advertisement listing. As will be understood by one skilled in the art, the estimated click-through rate output by the click-through rate estimator component 406 can be a function of features of the keyword for a respective auction. The sample auction generator component 404 receives, for each auction, the respective estimated click-through rate and computes a score for the prospective advertisement listing, wherein the score is a function of the proposed bid value for the prospective advertisement listing and the estimated click-through rate for the prospective advertisement listing for the respective auction output by the click-through rate estimator component 406.

The sample auction generator component 404 then determines, for each simulated auction, whether the prospective advertisement listing wins a respective auction based upon the minimum score for the respective auction and the score for the prospective advertisement listing for the respective auction. The predictor component 106 counts the number of simulated auctions won by the prospective advertisement listing for the bid value set forth by the prospective advertisement listing over the defined range of time, and a total count is a number of forecasted impressions for the prospective advertisement listing over the defined range of time.

More formally actions of the predictor component 106 can be described as follows. Given a prospective advertisement listing L, a computed number of sample auctions can be generated through utilization of the generative model 108, which has been trained for a keyword bid upon by the prospective advertisement listing L. After generating the sample auctions, the prospective advertisement listing L can be placed in each auction, and a respective click-through rate for L for a respective auction can be estimated in any suitable manner. Subsequently, utilizing the bid value for the proposed advertisement listing L, the predictor component 106 can compute a score for each auction that is a function of the bid value and the respective estimated click-through rate. Thereafter, the predictor component 106 can compute a total number of impressions by comparing respective minimum scores with respective scores for the prospective advertisement listing.

Formally, M_{L} can be the estimated number of auctions to be generated for the prospective advertisement listing L. The set of auctions can be represented as follows: A={A₁, A₂, . . . , A_{M}_{_{L}}}, where Aᵢ={Qᵢ,MSᵢ}, Qᵢ includes keyword features for the auction Aᵢ, and MSᵢ is a minimum score needed to win Aᵢ. The estimated click-through rate of the prospective advertisement listing L in Aᵢ can be denoted as follows: pclick(L, Qᵢ), ∀1≦i≦M_{L}. A forecasted number of impressions can thus be represented as follows:

Impressions(L)=|{i|bid(L)×pclick(L,Qᵢ)≧MSᵢ}|.

It can be ascertained that the predicted number of impressions depends upon M_{L}, the estimated number of auctions in which the prospective advertisement listing L will participate in the defined range of time. Estimation of M_{L} can be challenging due, at least in part to the fact that a number of searches that include the keyword can vary heavily across different time ranges, wherein such effect is particularly prominent amongst tail queries that are popular for a short period of time. For instance, queries for movie names peak during respective weeks of release and then drop significantly in subsequent weeks. Further, seasonal trends can also affect volume of searches that include a certain keyword. Additionally, estimation of M_{L} can be challenging as the prospective advertisement listing L may not participate in each auction for the keyword. For instance, an advertiser may wish to target a specific segment of users, and thus, may not participate in all potential auctions. Further, a sponsored search engine may filter out an advertisement due to low relevance for a particular user query or to introduce randomization.

Exemplary techniques that can be employed by the sample number calculator component 402 to compute M_{L} are now described. As alluded to above, the sample number calculator component 402 can decouple the problem of computing the number of sample auctions to generate into two separate problems. First, the sample number calculator component 402 can estimate a number of searches that include the keyword (desirably bid upon by the prospective advertisement listing) that will occur in the defined range of time. Second, the sample number calculator component 402 can determine the participation ratio for the prospective advertisement listing (the fraction of auctions in which the prospective advertisement listing is likely to participate).

For the first problem, the sample number calculator component 402 can model the volume of searches for a keyword as a time series, and use a first order dynamic linear model (DLM) to forecast the next point in the time series. For the second problem, the sample number calculator component 402 can estimate the participation ratio for each prospective advertisement listing using the auction logs 204. After solving the aforementioned two problems, the sample number calculator component 402 can obtain the number of auctions M_{L} in which the prospective advertisement listing L is likely to participate in the defined range of time using the following algorithm: M_{L}=N×γ_{L}, where N is the estimated number of searches in the defined range of time for the keyword bid upon by the prospective advertisement listing, and γ_{L} is the estimated participation ratio of the prospective advertisement listing.

Still more detail is now provided with respect to estimating a number of searches for a keyword in a defined range of time (e.g. one week). To form a time series, the time axis can be divided into bins, each of a defined range of time (such as one week). Utilizing the search logs of the sponsored search engine, a number of searches for the keyword is computed for each bin. For instance, Nₜ can denote a number of searches in the tth week for the keyword desirably bid upon by the prospective advertisement listing. Also 1≦t≦T can hold true, where T is the time range for which the number of auctions is desirably forecast (e.g., the test week). A DLM can be trained using {N₁, . . . , Nₜ, . . . , N_{T-1}}, and the DLM can be employed to predict the number of searches that include the keyword for the defined range of time (e.g., the test week). The use of first order DLMs for prediction of keyword traffic is motivated by the observation that traffic patterns are short lived, and DLMs are particularly well-suited for such short horizon forecasts. Assuming a first order DLM, a number of searches at a particular keyword at a time t, can be given by the following:

Nₜ=uₜ+vₜ,vₜ˜ [symbol] (0,V),

uₜ=uₜ₋₁+wₜ,wₜ˜ [symbol] (0,W),

where uₜ is the internal “state” of the series, V, W>0 are constants, and [symbol] (0,V) is the Gaussian distribution with mean 0 and variance V. It can be assumed that u₀˜ [symbol] (0,C₀) where C₀>0 is a constant.

Utilizing the above-mentioned model, the following update equations can be derived:

$$( {N}_{t} \vert {N}_{1} , … , {N}_{t - 1} ) ∼ 𝒩 ( {m}_{t - 1} , {C}_{t - 1} + V + W ) , \\ {m}_{t} = {m}_{t - 1} + \frac{{C}_{t - 1} + W}{{C}_{t - 1} + W + V} ( {N}_{t - 1} - {m}_{t - 1} ) , \\ {C}_{t} = \frac{( {C}_{t - 1} + W ) V}{{C}_{t - 1} + W + V} , \qquad ( 1 )$$

where m₀=0. Nₜ is a random variable that corresponds to a number of searches of a given keyword. Here notation is abused and the tth observed value is also denoted as Nₜ. For prediction, the sample number calculator component 402 can sample {N₁, . . . , Nₜ, . . . , N_{T-1}} using Eq. (1), while mₜ, Cₜ are then updated using the observed value for Nₜ. In an exemplary embodiment, the following parameters can be fixed, wherein such values have been selected using cross validation over several weeks of data: W=20, V=50.

As noted above, the sample number calculator component 402 can also estimate the participation ratio of the prospective advertisement listing. The participation ratio γ_{L} of the prospective advertisement listing L can be defined as the ratio of a number of auctions in which L participates in Tth test period to a total number of auctions for the keyword upon which L is bidding. In real life systems, an advertisement listing typically does not participate in all auctions for a particular keyword due to a variety of reasons including, but not limited to, budget constraints, advertiser specified targeting constraints, filtering by a sponsored search engine, etc. For instance, if a budget of a prospective advertisement listing is consumed, then such prospective advertisement listing cannot participate in future auctions for the keyword. Similarly, advertisers can provide certain constraints so as to target a particular group of users (while not targeting other groups of users). Consequently, in practice, the participation ratio tends to be relatively small for many prospective advertisement listings.

In an exemplary embodiment, γ_{L} can be estimated using time series forecasting methods. It can be ascertained, however, that a time span of most advertisement listings is relatively small, rendering training a DLM accurately somewhat problematic. A simplifying assumption can be made that γ_{L} remains constant over time. Using such assumption, γ_{L} can be estimated through analysis of the auction logs 204. Thus, a total number of wins for the prospective advertisement listing over a training time period can be divided by a total number of auctions in which the prospective advertisement listing participates in the training time period.

It can be noted that the above described techniques for computing the participation ratio of the prospective advertisement listing can apply to existing listings only, e.g., listings present in the auction logs 204. New listings, however, can pose a problem. New listings themselves can be further categorized into 1) new listing by an existing advertiser in the auction logs 204, and 2) new listings by an advertiser not existent in the auction logs 204 (a new advertiser). It can be ascertained that for the latter category, no information is available to estimate the participation ratio. For such listings, the sample number calculator component 402 can use a constant participation ratio obtained via cross validation. For existing advertisers, however, γ_{L} can be set to be a mean of the participation ratio for existing advertisement listings for the same advertiser. This can be expressed through the following:

$${γ}_{L} = \frac{{\sum }_{{L}_{A} ∈ {ℒ}_{A}} {γ}_{{L}_{A}}}{\vert {ℒ}_{A} \vert} ,$$

where [symbol] _{A} is the set of all listings by advertiser A who also owns listing L. It can be determined that rather than computing γ_{L} using the above algorithm, a constant value for γ_{L} can be employed.

In an exemplary embodiment, the predictor component 106 can be executed online; that is, an advertiser can set forth a prospective advertisement listing and proposed bid value, and such data can be provided to the predictor component 106, which performs actions described above to output a forecasted number of impressions for the prospective advertisement listing. In another exemplary embodiment, forecasting of impressions for a prospective advertisement and keyword can be undertaken offline; thus, forecasts for the prospective advertisement listing can be pre-computed for various bid values and stored in a look-up table. When the advertiser requests a forecast for a bid value, a simple look-up can be performed to return a forecasted number of impressions at the bid value.

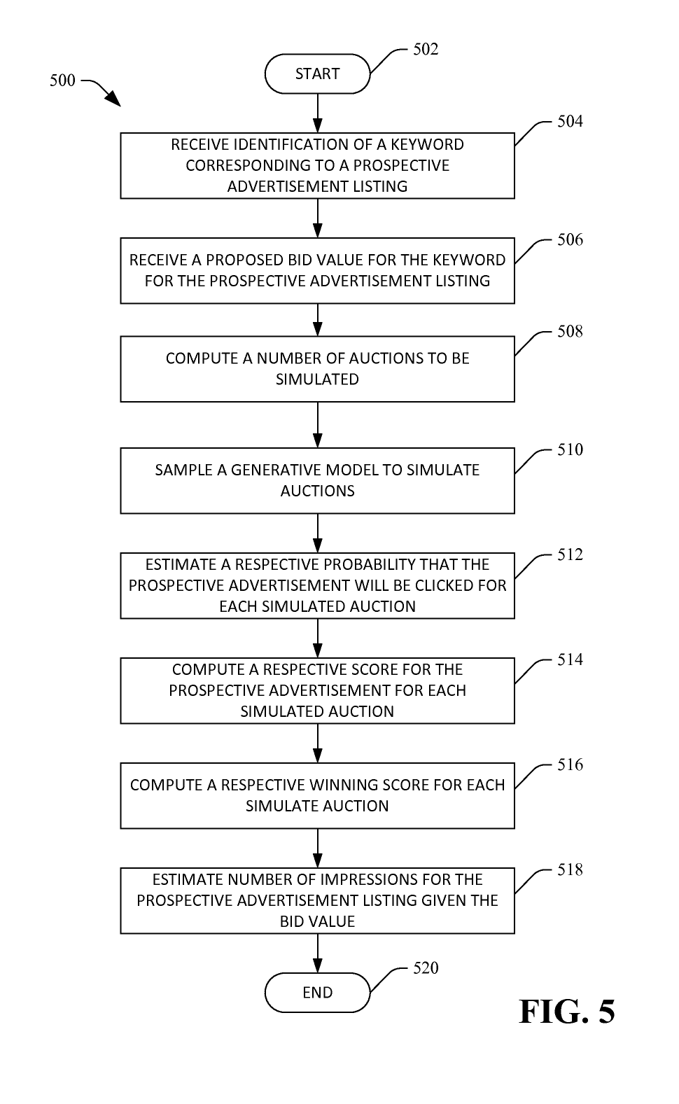

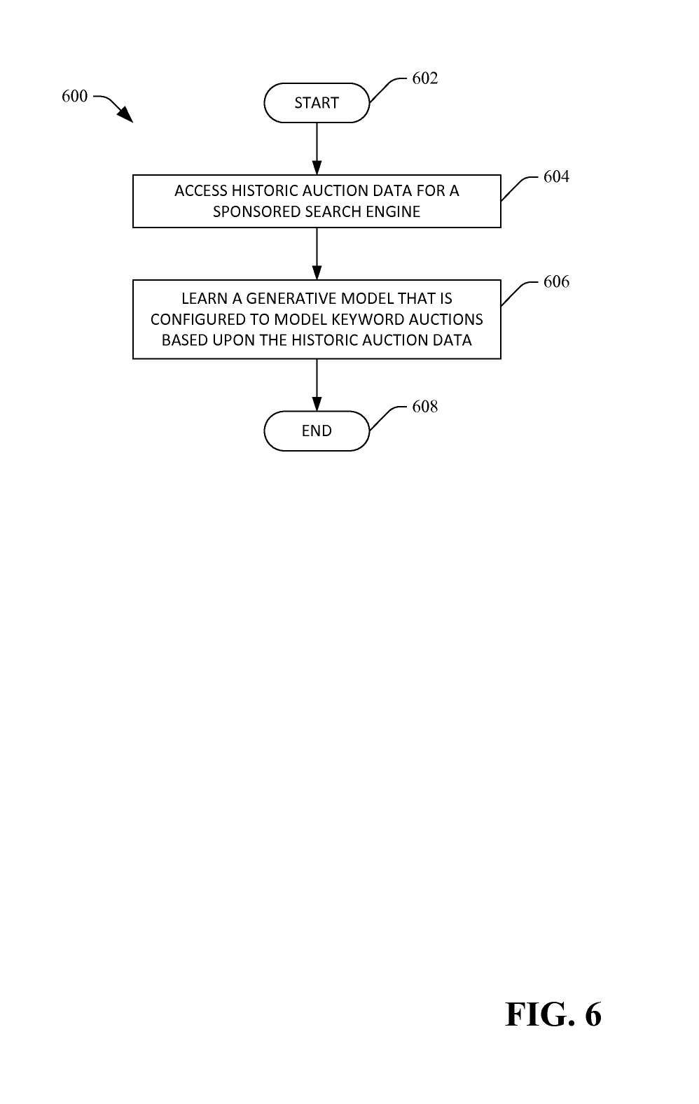

With reference now to FIGS. 5-6, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

With reference now to FIG. 5, an exemplary methodology 500 that facilitates forecasting a number of impressions for a prospective advertisement listing based upon a bid value is illustrated. The methodology 500 starts at 502, and at 504 an identification of a keyword corresponding to a prospective advertisement listing is received. In other words, an indication is received that a prospective advertisement listing is desirably presented responsive to users of a sponsored search engine issuing a query that comprises the keyword to a sponsored search engine.

At 506, a proposed bid value for the keyword for the prospective advertisement listing is received. Such proposed bid value can be with respect to some defined range of time, such as one week. At 508, a number of auctions to be simulated is computed. For instance, this number of auctions to be simulated can be computed responsive to receiving the indication and the proposed bid value. Exemplary techniques for computing the number of auctions to be simulated have been set forth above.

At 510, a generative model is sampled to simulate auctions, wherein the number of simulated auctions is equivalent to the number of auctions to be simulated computed at 508. At 512, for each simulated auction, a respective probability that the prospective advertisement listing will be clicked by an issuer of the keyword is estimated. At 514, for each simulated auction, a respective score for the prospective advertisement listing is computed based at least in part upon the bid value and the estimated probability that the prospective advertisement listing will be clicked.

At 516, for each simulated auction, a respective winning score is computed (or determined from the sampling of the generative model). At 518, a number of impressions for the prospective advertisement listing is estimated based upon the bid value. The number of impressions for the prospective advertisement listing can be estimated by counting a number of simulated auctions in which the prospective advertisement listing is determined to have won (the score of the prospective advertisement listing is above the winning score). The methodology 500 completes at 520.

Now referring to FIG. 6, an exemplary methodology 600 that facilitates learning a generative model that is configured to model keyword auctions based upon historical auction data is illustrated. The methodology 600 starts at 602, and at 604 historical auction data for a sponsored search engine is accessed. This stored auction data, for instance, can be for a particular keyword. At 606, a generative model that is configured to model auctions for the keyword is learned based upon the historical auction data. The method 600 can be repeated periodically such that the generative model relatively accurately reflects changing trends in auctions for the keyword. The methodology 600 completes at 608.

While the above description refers to outputting a value that indicates a number of impressions that are expected for a prospective advertisement listing over a defined range of time, it is to be understood that, in another exemplary embodiment, a probability distribution over a possible number of impressions can be set forth for an advertiser.

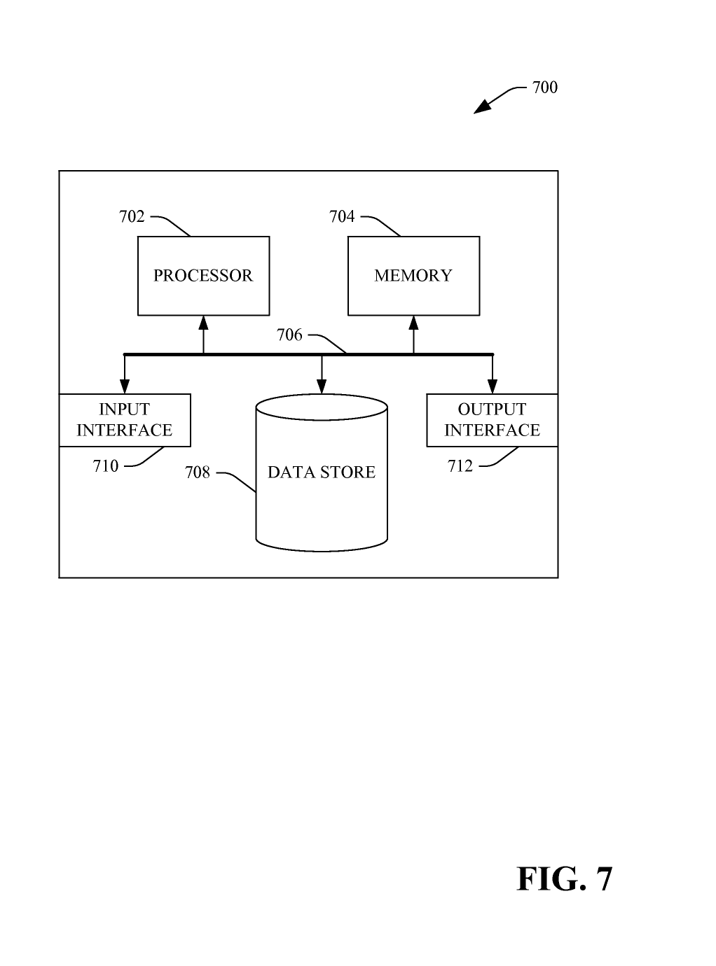

Now referring to FIG. 7, a high-level illustration of an exemplary computing device 700 that can be used in accordance with the systems and methodologies disclosed herein is illustrated. For instance, the computing device 700 may be used in a system that supports forecasting a number of impressions for a prospective advertisement listing. In another example, at least a portion of the computing device 700 may be used in a system that supports learning a generative model that models auctions for a keyword. The computing device 700 includes at least one processor 702 that executes instructions that are stored in a memory 704. The memory 704 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store historic auction data, a generative model, a look-up table of forecast impressions numbers, etc.

The computing device 700 additionally includes a data store 708 that is accessible by the processor 702 by way of the system bus 706. The data store 708 may be or include any suitable computer-readable storage, including a hard disk, memory, etc. The data store 708 may include executable instructions, search logs, auction logs, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

Additionally, while illustrated as a single system, it is to be understood that the computing device 700 may be a distributed system. Thus, for instance, several devices may be in communication by way of a network connection and may collectively perform tasks described as being performed by the computing device 700.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method that facilitates forecasting a number of impressions of a prospective advertisement listing with respect to a keyword over a defined range of time in a sponsored search engine, the method comprising:
receiving an indication that the prospective advertisement listing is desirably presented responsive to users issuing a query that comprises the keyword to the sponsored search engine;
receiving a proposed bid value for the prospective advertisement listing for the keyword;
generating a particular number of sample auctions responsive to receiving the indication and the proposed bid value, wherein each sample auction comprises a respective winning score, and wherein generating a sample auction comprises sampling a generative model that models auctions for the keyword;
for each sample auction, computing a respective advertisement listing score based at least in part upon the proposed bid value for the prospective advertisement listing;
for each sample auction, determining whether the respective advertisement listing score is above the respective winning score; and
forecasting the number of impressions of the prospective advertisement listing over the defined range of time based at least in part upon the determining whether the respective advertisement listing score is above the respective winning score for each sample auction.

2. The method of claim 1, further comprising computing the particular number of sample auctions.

3. The method of claim 2, wherein computing the particular number of sample auctions comprises estimating a number of times that users of the sponsored search engine will issue the keyword as at least a portion of a query over the defined range of time.

4. The method of claim 3, wherein estimating the number of instances that users of the sponsored search engine will issue the keyword as at least the portion of the query over the defined length of time comprises utilizing a dynamic linear model to predict the number of instances that users of the sponsored search engine will issue the keyword as at least the portion of the query over the defined range of time.

5. The method of claim 3, wherein computing the particular number of sample auctions comprises estimating a percentage of auctions for the keyword in which the prospective advertisement listing will participate.

6. The method of claim 1, wherein the generative model is a Bayesian network.

7. The method of claim 1, wherein computing the respective advertisement listing score comprises:
estimating a respective probability that a user of the sponsored search engine, subsequent to issuing the keyword to the sponsored search engine, will select the prospective advertisement listing; and
computing the respective advertisement listing score based at least in part upon the bid value and the respective probability.

8. The method of claim 1, wherein the generative model is configured to model features of the keyword.

9. The method of claim 8, wherein the features of the keyword comprise:
locations from which the keyword was issued;
times that the keyword was issued; and
data pertaining to a browser that was employed when the keyword was issued.

10. The method of claim 1, wherein the prospective advertisement listing is a new advertisement listing for an advertiser that has previously set forth other advertisement listings for presentment via the sponsored search engine.

11. The method of claim 1, wherein the prospective advertisement listing is a new advertisement listing for a new advertiser that has not previously set forth any other advertisement listings for presentment via the sponsored search engine.

12. A system that facilitates predicting a number of impressions for a prospective advertisement listing with respect to a keyword in a sponsored search engine, the system comprising:
a receiver component that receives:
an indication that the prospective advertisement listing is desirably presented by an advertiser to users of the sponsored search engine when the keyword is issued as at least a portion of a query by the users of the sponsored search engine; and
a bid value set forth by the advertiser for the prospective advertisement listing; and
a predictor component that forecasts a number of impressions of the prospective advertisement listing to users of the sponsored search engine for a defined range of time based at least in part upon the bid value set forth by the advertiser, wherein the predictor component forecasts the number of impressions of the prospective advertisement listing by simulating a computed number of auctions for the keyword through utilization of a generative model that models auctions for the keyword and determining whether the prospective advertisement listing wins each auction based at least in part upon the bid value set forth by the advertiser.

13. The system of claim 12, wherein the advertiser has not previously set forth any bids for advertisement listings to the sponsored search engine.

14. The system of claim 12, wherein the advertiser has not previously set forth any bids for the prospective advertisement listing to the sponsored search engine.

15. The system of claim 12, wherein the generative model is a Bayesian network.

16. The system of claim 15, wherein the predictor component predicts the number of impressions of the prospective advertisement listing to users based at least in part upon observed features corresponding to the keyword when issued by users of the sponsored search engine, the observed features comprising locations from which the keyword has been issued and times that the keyword has been issued.

17. The system of claim 15, wherein the predictor component predicts the number of impressions of the prospective advertisement listing based at least in part upon historic bid values submitted by other advertisers for the keyword.

18. The system of claim 12, wherein the predictor component comprises a sample number calculator component that computes the computed number of auctions to simulate based at least in part upon a predicted number of times that the keyword will be issued by users of the sponsored search engine in the defined range of time.

19. The system of claim 18, wherein the sample number calculator component computes the computed number of auctions to simulate based at least in part upon a predicted percentage of auctions for the keyword in which the prospective advertisement listing will participate.

20. A computer-readable data storage device comprising instructions that, when executed by a processor, cause the processor to perform acts comprising:
receiving, from an advertiser, an indication that the advertiser desires to have a prospective advertisement listing provided to users of a sponsored search engine responsive to the users issuing a keyword to the sponsored search engine over a defined range of time;
receiving, from the advertiser, a bid value for the prospective advertisement for the defined range of time;
responsive to receiving the indication and the bid value, estimating a number of auctions for the keyword in which the prospective advertisement listing will participate in the defined range of time, wherein estimating the number of auctions for the keyword in which the prospective advertisement listing will participate comprises:
estimating a number of instances that the keyword will be issued to the sponsored search engine by the users of the sponsored search engine; and
estimating a percentage of auctions for the keyword in which the prospective advertisement listing will participate;
generating a number of sample auctions for the keyword, wherein the number of sample auctions for the keyword is equivalent to the number of auctions for the keyword in which the prospective advertisement listing will participate in the defined time range, wherein each sample auction in the number of sample auctions is generated by sampling a Bayesian network that models auctions for the keyword, and wherein a determination is made for each sample auction regarding whether the prospective advertisement listing has won a respective auction based at least in part upon the bid value; and
estimating a number of impressions of the prospective advertisement listing for the defined range of time based at least in part upon the determination, for each sample auction, regarding whether the prospective advertisement listing has won the respective auction.
